(19) United States
(12) Patent Application Publication
(10) Pub. No.: US 2013/0228021 A1
(43) Pub. Date: Sep. 5, 2013

(54) LOAD FLEXURE ASSEMBLY

(71) Applicants: Robert G. Wiley, Franklin, TN (US); Brett Clark, Whites Creek, TN (US); John Lower, Franklin, TN (US); Jason Troyer, Shelbyville, TN (US)

(72) Inventors: Robert G. Wiley, Franklin, TN (US); Brett Clark, Whites Creek, TN (US); John Lower, Franklin, TN (US); Jason Troyer, Shelbyville, TN (US)

(21) Appl. No.: 13/782,716

(22) Filed: Mar. 1, 2013

Related U.S. Application Data
(60) Provisional application No. 61/605,619, filed on Mar. 1, 2012.

(51) Int. Cl. G01L 1/22; G01L 1/20

(52) U.S. Cl. CPC G01L 1/22; G01L 1/20
USPC 73/862.045; 73/862.041; 29/428

(57) ABSTRACT

In accordance with present invention, a load flexure assembly is provided. The load cell assembly includes a plurality of load cells (i.e., two or more) connected between a top plate and a bottom plate. The top plate and bottom plate can be arranged substantially in parallel, one above the other, with the plurality of load cells coupled in between the two.

### CROSS-REFERENCE TO RELATED APPLICATIONS

This application claims the benefit, under 35 U.S.C §119(e), to U.S. Provisional Patent Application No. 61/605,619, entitled LOAD FLEXURE ASSEMBLY, filed on Mar. 1, 2012, in the United States Patent and Trademark Office, the disclosure of which is incorporated herein in its entirety by reference.

### FIELD OF INTEREST

The present inventive concepts relate to the field of devices for sensing and responding to or compensating for loads.

### BACKGROUND

In various applications, it would be useful to have a unit or device that can be disposed between two objects to sense and respond to loads. It would be advantageous to have such a unit or device in a small, or scalable, size that is relatively inexpensive. As a result, to some degree, use of existing technologies may be advantageous to form a unique device that could be small in scale and configured to sense and respond to loads.

### SUMMARY OF INVENTION AND EXAMPLE EMBODIMENTS

In accordance with one aspect of the present invention, provided is a load flexure assembly comprising a top plate, a bottom plate, and a plurality of load cells coupled between the top and bottom plates.

In various embodiments, the top and bottom plates are arranged substantially in parallel with the plurality of load cells coupled in between the top and bottom plates.

In various embodiments, one or more of the plurality of load cells are thin-beam flexure load cells.

In various embodiments, one or more of the plurality of load cells comprises a flexure and a strain gauge.

In various embodiments, one or more of the plurality of load cells is configured to generate an electrical output indicative of an applied or experienced load.

In various embodiments, at least some of the load cells from the plurality of load cells are peripherally disposed around one or more of the top and bottom plates.

In various embodiments, the plurality of load cells comprises four load cells, with each of the four load cells coupled proximate to a different corner of the top and bottom plates.

In various embodiments, one of the four load cells is coupled to each side of the top and bottom plates, respectively.

In various embodiments, two of the four load cells are coupled to one side of the top and bottom plates and the other two load cells are coupled to opposite side of the top and bottom plates.

In various embodiments, the plurality of load cells comprises one or more load cells intermediately coupled to sides of the top and bottom plates.

In various embodiments, the plurality of load cells comprises eight load cells, with two load cells coupled to each side of the top and bottom plates.

In various embodiments, the top and bottom plates have substantially the same profile from top and bottom views.

In various embodiments, the top and bottom plates have different profiles from top and bottom views.

In various embodiments, all of the load cells from the plurality of loads cells have the same weight capacities.

In various embodiments, at least one of load cells from the plurality of loads cells has a different weight capacity than one or more other load cell.

According to another aspect of the present invention, provided is a load flexure assembly, comprising a top plate, a bottom plate, and at least four thin-beam flexure load cells coupled to sides of the top and bottom plates, which are maintained spaced apart and disposed in parallel when a load is not applied.

In various embodiments, each thin-beam flexure load cell is configured to output an electrical signal indicative of an applied load.

In various embodiments, each of the four thin-beam flexure load cells is coupled proximate to a different corner of the top and bottom plates.

In various embodiments, two of the four thin-beam flexure load cells are coupled to one side of the top and bottom plates and the other two thin-beam flexure load cells are coupled to opposite side of the top and bottom plates.

In accordance with another aspect of the invention, provided is a method of making a load flexure assembly, comprising providing a top plate, providing a bottom plate, and coupling a plurality of load cells coupled between the top and bottom plates, such that the top and bottom plates are maintained spaced apart and substantially in parallel in the absence of an applied load.

In various embodiments of the method, the load flexure assembly is configured and arranged as shown in and described with respect to the drawings.

In accordance with various aspects of the invention, there is provided a load flexure assembly as described in the figures.

In accordance with various aspects of the invention, there is provided a method as described in the figures.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a perspective view of a load flexure assembly, in accordance with aspects of the present invention;

FIG. 2 is a different perspective view of the load flexure assembly of FIG. 1, in accordance with aspects of the present invention;

FIG. 3 is a top view of the load flexure assembly of FIG. 1, in accordance with aspects of the present invention;

FIG. 4 is a side view of the load flexure assembly of FIG. 1, in accordance with aspects of the present invention;

FIG. 5 is a different side view of the load flexure assembly of FIG. 1, in accordance with aspects of the present invention;

FIG. 6 is a cross-sectional view taken along lines A-A of the load flexure assembly of FIG. 5, in accordance with aspects of the present invention;

FIG. 7-11 are top views showing different embodiments of the load flexure assembly, in accordance with aspects of the present invention; and

FIG. 12 is a flowchart depicting an embodiment of a method of making a load flexure assembly, in accordance with aspects of the present invention.

### DETAILED DESCRIPTION OF PREFERRED EMBODIMENTS

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing.

In accordance with present invention, a load flexure assembly is provided. The load cell assembly includes a plurality of load cells (i.e., two or more) connected between a top plate and a bottom plate. The top plate and bottom plate can be arranged substantially in parallel, one above the other, with the plurality of load cells coupled in between the two.

In various embodiments, the bottom plate can rest or be secured to a surface and the top plate can be arranged to receive a load.

The plurality of load cells can include thin beam flexure load cells, comprising a flexure and a strain gauge.

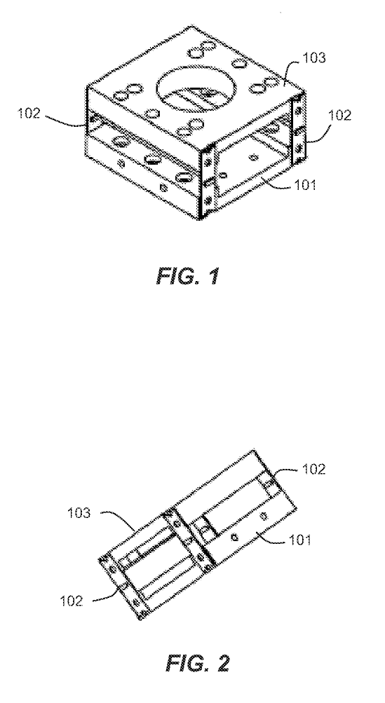

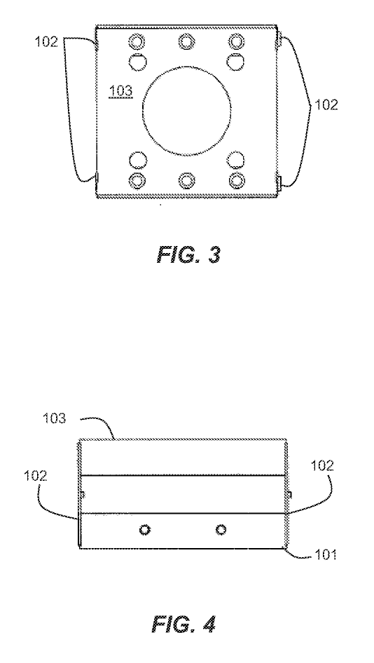

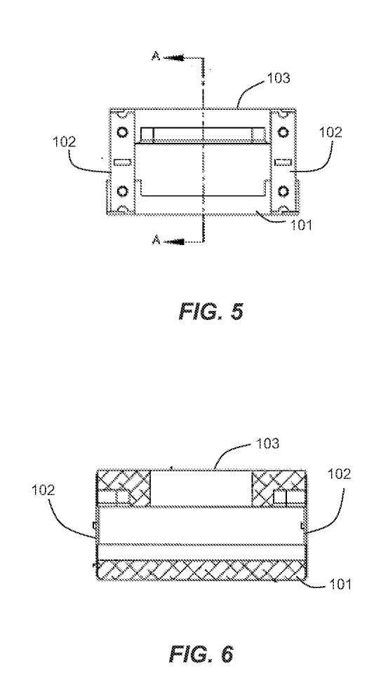

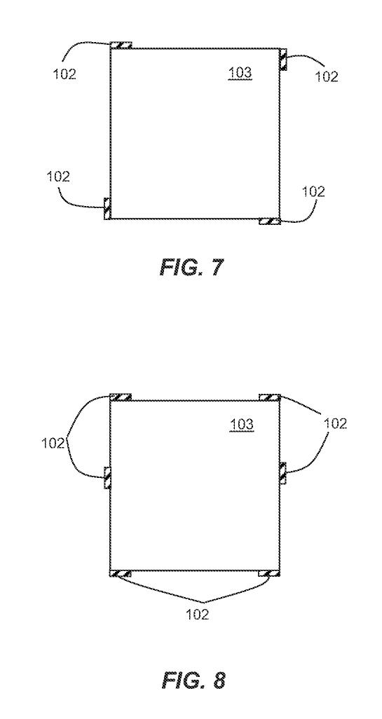

FIG. 1 is a perspective view of a load flexure assembly 100, in accordance with aspects of the present invention. FIG. 2 is a different perspective view of the load flexure assembly 100 of FIG. 1. FIG. 3 is a top view of the load flexure assembly 100 of FIG. 1. FIG. 4 is a side view of the load flexure assembly 100 of FIG. 1. FIG. 5 is a different side view of the load flexure assembly 100 of FIG. 1. And FIG. 6 is a cross-sectional view taken along lines A-A of the load flexure assembly 100 of FIG. 5. FIG. 7-11 are top views showing different embodiments of the load flexure assembly 100, in accordance with aspects of the present invention.

The bottom and top plates 101, 103 can have the same profile, e.g., length and width when viewed from the top or bottom, as is shown in FIGS. 1-11. But this need not be the case in other embodiments.

The load flexure assembly 100 of this embodiment includes a bottom plate 101, four thin-beam load cells 102, and a top plate 103. The bottom and top plates 101, 101 are shown to be relatively thin (i.e., thinner) in thickness than in length or width in the depicted embodiments. But in other embodiments, this need not be the case. For example, top plate 103 could be coupled to another surface by a plurality of flexure, wherein such surface could be a surface of any type of object. However, as shown and described herein, the load flexure assembly is a unit that can be used in any of a variety of applications and engage other surfaces or object via the bottom and top plates 101, 103.

In various embodiments, each load cell 102 can comprises a flexure coupled to a strain gauge. The flexures can be substantially rigid in a horizontal direction and flexible in the vertical direction—relative to the bottom and top plates 101, 103. In various embodiments, each load cell 102 has the same weight capacity. In some embodiments, each load cell has a capacity of up to 40 pounds. In other embodiments, each load cell has a capacity of up to 20 pounds. In other embodiments, each load cell has a capacity of up to 10 pounds. In other embodiments, each load cell has a capacity of up to 5 pounds. In other embodiments, each load cell has a capacity of up to 2 pounds. In other embodiments, each load cell has a capacity of up to 1 pound. In other embodiments, each load cell has a capacity of up to 0.5 pounds. In other embodiments, each load cell has a capacity of up to 0.25 pounds. In other embodiments, load cells from the plurality of loads cells have different weight capacities.

Thus, the load cell 102 can be configured to act as a strain gauge and, in various embodiments, can include balancing, compensating, and conductive elements, laminated to a beam to provide stability and reliability. The load cells 102 can be configured to output an electrical signal indicative of an applied or experienced load. The electrical output (or signal) can be used a compensation apparatus that compensates for and/or balances out the load. In various embodiments, therefore, the load flexure assembly 100 can be small scale and configured to sense and/or compensate for loads.

The four thin-beam load cells 102 can be four full-bridge thin-beam load cells 102. For example, the four full-bridge thin-beam load cells 102 can be LCL Series full-bridge thin-beam load cells made by Omega Engineering, Inc., e.g., LCL-010 model full-bridge thin-beam load cells. Such load cells are generally known in the art and not discussed in detail herein.

In this embodiment, the four load cells 102 are arranged at the four corners of the bottom and top plates 101, 103, which are quadrangular plates in this embodiment. In this embodiment, two load cells 102 are arranged on one side of the bottom and top plates 101, 103 and the other two load cells 102 are arranged on an opposite side of the bottom and top plates 101, 103. egg, e.g., FIG. 5. Therefore, the other two (opposing) sides of the bottom and top plates do not have load cells in this embodiment, see, e.g., FIG. 4.

In the embodiment of FIGS. 1-6, off-axis loads or torsional loads applied to the top plate 103 are self-cancelling, reducing errors when measuring loads with the load flexure assembly 100.

In this embodiment, the load flexure assembly 100 achieves substantially no stiction. In this arrangement, the load flexure assembly can achieve high accuracy, e.g., a few grams or less in a load flexure assembly 100 configured to measure loads of 80 pounds or more.

The bottom and top plates can be made from any of a variety of materials, e.g., metal, plastics, and so on. Preferably the bottom and top plates 101, 103 are made of a substantially rigid material that enable loads on the top plate 103 to be translated to the load cells 102, e.g., substantially without loss or dampening.

In some embodiments the load cell flexure assembly 100 can be about 34 mm, or less, in height and the bottom and top plates 101, 103 can be square having a width of about 65 mm, or less. In other embodiments the dimensions could be different. The dimensions used herein are merely illustrative.

The load cells 102 can be coupled to the bottom and top plates 101, 103 by any of a variety of mechanisms, e.g., screws, bolts, clamps, and/or adhesives.

FIG. 7-11 are top views showing different embodiments of the load flexure assembly 100, in accordance with aspects of the present invention. In some embodiments, there could be four load cells, one at each corner of the bottom and top plates 101, 103, but with only one per side, e.g., as in FIG. 7. In still other embodiments, one or more load cells 102 could be located intermediately, e.g., about halfway between corners of the bottom and top plates, e.g., as in FIGS. 8 and 10.

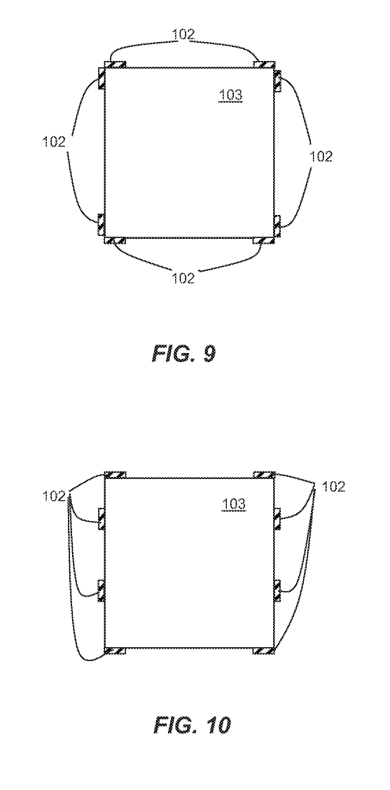

In other embodiments, other placements of load cells could be provided, such as 8 load cells 102, with 2 load cells on each side of the bottom and top plates 101, 103. (See, e.g., FIGS. 9 and 10). This could be implemented in 2 load cells 102 at each corner of the bottom and top plates 101, 103, e.g., as in FIG. 9. Or, as another example, this could be implemented with some load cells 102 at the corners and some located intermediately, e.g., as in FIG. 10.

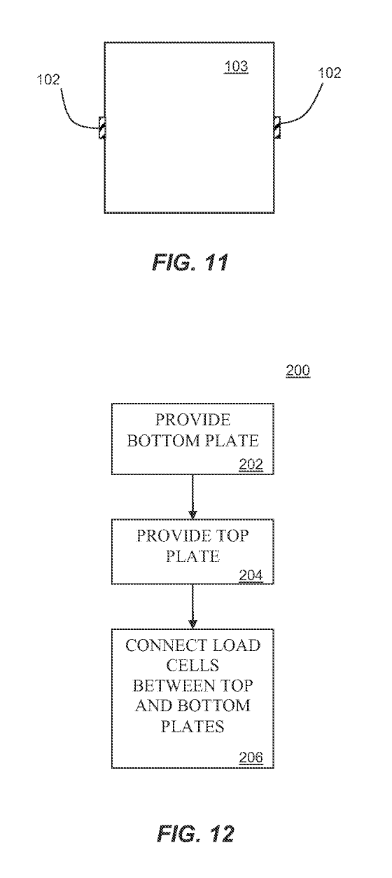

As shown in FIG. 11, the load flexure assembly 100, can include 2 load cells, e.g., one on each side of the bottom and top plates 101, 103.

In the embodiments shown, the load cells are peripherally disposed around one or more of the top and bottom plates. In these embodiments, the bottom and top plates have the same dimensions, from a top or bottom view of the load flexure assembly. But in other embodiments, this need not be the case. For example, the bottom plate 103 could be longer and/or wider than the top plate 103, or vice versa. In various embodiments, therefore, load cells may be peripherally coupled to some portions the bottom and/or top plates 101, 103, but internally coupled portions of the bottom and/or top plates 101, 103. By “internally” coupled, it is meant that the connection between a load cell and a bottom or top plate is at any location within the periphery of such bottom or top plate.

FIG. 12 is a flowchart depicting an embodiment of a method of making a load flexure assembly 200, in accordance with aspects of the present invention.

According to method 200, a bottom plate 101 is provided. A top plate 103 is also provided. And a plurality of load cells 102, e.g., 2, 4, 6, or 8 load cells 102, is provided between the top and bottom plates. The load cells coupe together the bottom and top plates 101, 103 to form a load flexure assembly, e.g., as shown and described with respect to FIGS. 1-11 above.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein.

We claim:

1. A load flexure assembly comprising:
a top plate;
a bottom plate; and
a plurality of load cells coupled between the top and bottom plates.

2. The load flexure assembly, wherein the top and bottom plates are arranged substantially in parallel with the plurality of load cells coupled in between the top and bottom plates.

3. The load flexure assembly of claim 1, wherein one or more of the plurality of load cells are thin-beam flexure load cells.

4. The load flexure assembly of claim 1, wherein one or more of the plurality of load cells comprises a flexure and a strain gauge.

5. The load flexure assembly of claim 1, wherein one or more of the plurality of load cells is configured to generate an electrical output indicative of an applied or experienced load.

6. The load flexure assembly of claim 1, wherein at least some of the load cells from the plurality of load cells are peripherally disposed around one or more of the top and bottom plates.

7. The load flexure assembly of claim 1, wherein the plurality of load cells comprises four load cells, with each of the four load cells coupled proximate to a different corner of the top and bottom plates.

8. The load flexure assembly of claim 7, wherein one of the four load cells is coupled each to side of the top and bottom plates, respectively.

9. The load flexure assembly of claim 7, wherein two of the four load cells are coupled to one side of the top and bottom plates and the other two load cells are coupled to opposite side of the top and bottom plates.

10. The load flexure assembly of claim 1, wherein the plurality of load cells comprises one or more load cells intermediately coupled to sides of the top and bottom plates.

11. The load flexure assembly of claim 1, wherein the plurality of load cells comprises eight load cells, with two load cells coupled to each side of the top and bottom plates.

12. The load flexure assembly of claim 1, wherein the top and bottom plates have substantially the same profile from top and bottom views.

13. The load flexure assembly of claim 1, wherein the top and bottom plates have different profiles from top and bottom views.

14. The load flexure assembly of claim 1, wherein all of the load cells from the plurality of loads cells have the same weight capacities.

15. The load flexure assembly of claim 1, wherein at least one of load cells from the plurality of loads cells has a different weight capacity than one or more other load cell.

16. A load flexure assembly comprising:
a top plate;
a bottom plate; and
at least four thin-beam flexure load cells coupled to sides of the top and bottom plates, which are maintained spaced apart and disposed in parallel when a load is not applied.

17. The load flexure assembly of claim 16, wherein each thin-beam flexure load cell is configured to output an electrical signal indicative of an applied load.

18. The load flexure assembly of claim 16, wherein each of the four thin-beam flexure load cells is coupled proximate to a different corner of the top and bottom plates.

19. The load flexure assembly of claim 18, wherein two of the four thin-beam flexure load cells are coupled to one side of the top and bottom plates and the other two thin-beam flexure load cells are coupled to opposite side of the top and bottom plates.

20. A method of making a load flexure assembly, comprising:
providing a top plate;
providing a bottom plate; and
coupling a plurality of load cells coupled between the top and bottom plates, such that the top and bottom plates are maintained spaced apart and substantially in parallel in the absence of an applied load.
